(19) United States
(12) Patent Application Publication
(10) Pub. No.: US 2025/0007072 A1
(43) Pub. Date: Jan. 2, 2025

(54) BATTERY PACK

(71) Applicant: TOYOTA JIDOSHA KABUSHIKI KAISHA, Toyota-shi (JP)

(72) Inventors: Motokuni MARUHASHI, Toyota-shi (JP); Masaki SHIMADA, Toyota-shi (JP)

(73) Assignee: TOYOTA JIDOSHA KABUSHIKI KAISHA, Toyota-shi (JP)

(21) Appl. No.: 18/744,937

(22) Filed: Jun. 17, 2024

(30) Foreign Application Priority Data
Jun. 27, 2023 (JP) 2023-105207

(51) Int. Cl. H01M 50/262; H01M 50/209; H01M 50/271

(52) U.S. Cl. CPC H01M 50/262; H01M 50/209; H01M 50/271; H01M 2220/20

(57) ABSTRACT

A battery pack includes: a battery stack; a lower case that houses the battery stack; an upper cover that covers the battery stack; a restraint band that restrains the upper cover; a first fastening member that fastens the upper cover to the lower case; and a second fastening member that fastens the restraint band to the upper cover. The upper cover has a top wall provided above the battery stack, and the top wall includes a base for fastening the second fastening member. The restraint band has a top plate portion provided above the top wall, the top plate portion has a bead extending in one direction, and the bead has a covering portion that covers the base. The second fastening member fastens the covering portion to the base.

### CROSS REFERENCE TO RELATED APPLICATIONS

This nonprovisional application is based on Japanese Patent Application No. 2023-105207 filed on Jun. 27, 2023 with the Japan Patent Office, the entire contents of which are hereby incorporated by reference.

### BACKGROUND

### Field

The present disclosure relates to a battery pack.

### Description of the Background Art

For example, Japanese Patent Laying-Open No. 2019-197662 discloses a power storage device including an exterior package that houses a plurality of battery elements and a fixing band that is wound around the exterior package.

### SUMMARY

In the power storage device described in Japanese Patent Laying-Open No. 2019-197662, it is necessary to increase the thickness of the fixing band in order to more reliably suppress the expansion of the exterior package, thus resulting in an increased weight of the fixing band.

An object of the present disclosure is to provide a battery pack to suppress expansion of an upper cover while avoiding a significant weight increase of a restraint band.

A battery pack according to one aspect of the present disclosure includes: a battery stack including a plurality of power storage cells arranged side by side in one direction; a lower case that houses the battery stack; an upper cover that covers the battery stack; a restraint band that restrains the upper cover; a first fastening member that fastens the upper cover to the lower case; and a second fastening member that fastens the restraint band to the upper cover, wherein the upper cover has a top wall provided above the battery stack, the top wall includes a base for fastening the second fastening member, the restraint band has a top plate portion provided above the top wall, the top plate portion has a bead extending in the one direction, the bead has a covering portion that covers the base, and the second fastening member fastens the covering portion to the base.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a configuration of an upper cover and a restraint band of a battery pack according to an embodiment of the present disclosure.

FIG. 2 is a schematic cross-sectional view of the battery pack.

### DESCRIPTION OF THE PREFERRED EMBODIMENTS

Embodiments of the present disclosure will be described with reference to the drawings. In the drawings referred to below, the same or corresponding members are denoted by the same reference numerals.

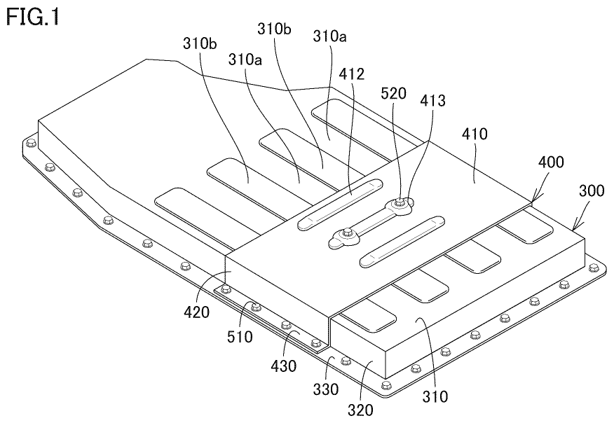

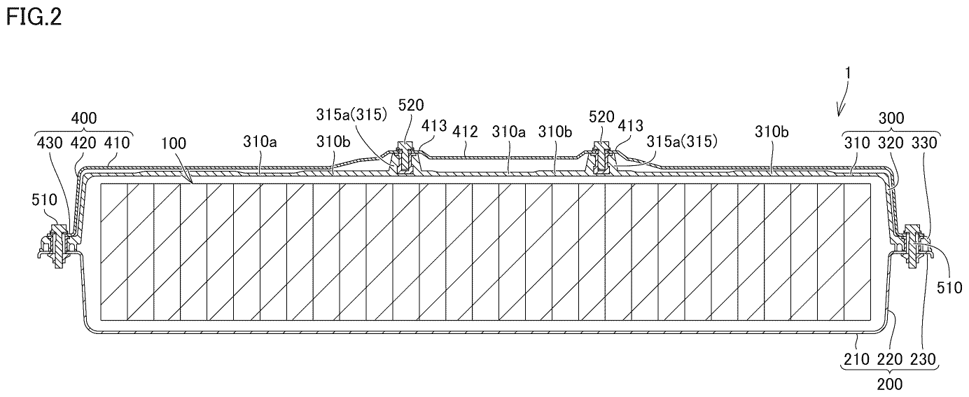

FIG. 1 is a perspective view schematically showing a configuration of an upper cover and a restraint band of a battery pack according to an embodiment of the present disclosure. FIG. 2 is a schematic cross-sectional view of the battery pack. The battery pack 1 is mounted on, for example, a vehicle.

As shown in FIGS. 1 and 2, the battery pack 1 includes a battery stack 100, a lower case 200, an upper cover 300, a restraint band 400, a first fastening member 510, and a second fastening member 520.

The battery stack 100 includes a plurality of power storage cells arranged in one direction (for example, the width direction of the vehicle). Examples of the power storage cells include lithium ion batteries. Each power storage cell is formed in a flat rectangular parallelepiped. The battery stack 100 may include a resin frame disposed between a pair of power storage cells adjacent to each other.

The lower case 200 accommodates the battery stack 100. The lower case 200 is open upward. The lower case 200 includes a bottom wall 210, a peripheral wall 220, and a flange 230.

The bottom wall 210 supports the battery stack 100. The peripheral wall 220 stands from the peripheral edge portion of the bottom wall 210. The flange 230 projects outwardly from the upper end portion of the peripheral wall 220.

The upper cover 300 covers the battery stack 100. The upper cover 300 opens downward. The upper cover 300 includes a top wall 310, a peripheral wall 320, and a flange 330.

The top wall 310 is disposed above the battery stack 100 and covers the battery stack 100. The peripheral wall 320 extends downward from the peripheral edge portion of the top wall 310. The flange 330 protrudes outward from a lower end portion of the peripheral wall 320.

As shown in FIG. 2, the top wall 310 has a thin portion 310a and a thick portion 310b having a thickness larger than that of the thin portion 310a. As shown in FIG. 1, each of the thin portion 310a and the thick portion 310b extends in a direction perpendicular to both the one direction and the upward/downward direction (for example, the front-rear direction of the vehicle). As shown in FIGS. 1 and 2, the thin portions 310a and the thick portions 310b are alternately arranged in one direction.

The top wall 310 has a base 315 for fastening the second fastening member 520. As shown in FIG. 2, the base 315 is formed in the thick portion 310b. In the present embodiment, the base 315 has a pair of base portions 315a provided at positions separated from each other in one direction. Each base portion 315a is formed at the thick portion 310b. The thin portion 310a is formed between the pair of thick portions 310b on which the base portion 315a is formed.

The restraint band 400 restrains the upper cover 300. The restraint band 400 has a function of suppressing deformation of the upper cover 300 when the pressure in the lower case 200 and the upper cover 300 increases. That is, the restraint band 400 has a function of reinforcing the upper cover 300. The restraint band 400 has a top plate portion 410, a pair of side walls 420, and a flange 430.

The top plate portion 410 is provided above the top wall 310. Each of the side walls 420 extends downward from an end portion of the top plate portion 410 in one direction. The flange 430 protrudes outward in one direction from the lower end portion of the side wall 420.

The top plate portion 410 has beads 412 extending in one direction. The bead 412 has a covering portion 413 covering the base 315.

The first fastening member 510 fastens the upper cover 300 to the lower case 200. As shown in FIG. 2, the first fastening member 510 fastens the flange 330 of the upper cover 300 to the flange 230 of the lower case 200. In the present embodiment, the first fastening member 510 fastens the flange 430 of the restraint band 400 together with the flange 330 of the upper cover 300 to the flange 230 of the lower case 200.

The second fastening member 520 fastens the restraint band 400 to the upper cover 300. More specifically, the second fastening member 520 fastens the covering portion 413 to the base 315. As shown in FIG. 2, the second fastening member 520 is provided in a plane (a plane shown in FIG. 2) orthogonal to both the one direction and the upward/downward direction and including the first fastening member 510.

As described above, in the battery pack 1 of the present embodiment, since the top plate portion 410 of the restraint band 400 has the bead 412 and the covering portion 413 of the bead 412 is fastened to the base 315 by the second fastening member 520, the rigidity of the top wall 310 and the top plate portion 410 is effectively improved. Therefore, it is possible to suppress the expansion of the upper cover 300 while avoiding a significant increase in the weight of the restraint band 400.

It will be understood by those skilled in the art that the exemplary embodiments described above are specific examples of the following aspects.

### Aspect 1

A battery pack comprising:
a battery stack including a plurality of power storage cells arranged side by side in one direction;
a lower case that houses the battery stack;
an upper cover that covers the battery stack;
a restraint band that restrains the upper cover;
a first fastening member that fastens the upper cover to the lower case; and
a second fastening member that fastens the restraint band to the upper cover, wherein
the upper cover has a top wall provided above the battery stack,
the top wall includes a base for fastening the second fastening member,
the restraint band has a top plate portion provided above the top wall,
the top plate portion has a bead extending in the one direction,
the bead has a covering portion that covers the base, and
the second fastening member fastens the covering portion to the base.

In this battery pack, since the top plate portion of the restraint band has a bead and the covering portion of the bead is fastened to the base by the second fastening member, the rigidity of the top wall of the upper cover and the top plate portion of the restraint band is effectively improved. Therefore, it is possible to suppress the expansion of the upper cover while avoiding a significant increase in the weight of the restraint band.

### Aspect 2

The battery pack according to Aspect 1, wherein
the top wall has
   a thin portion,
   a thick portion having a thickness larger than a thickness of the thin portion, and
the base is formed at the thick portion.

### Aspect 3

The battery pack according to Aspect 2, wherein
the base has a pair of base portions provided at positions separated from each other in the one direction, and
the thin portion is formed between the pair of base portions.

In this aspect, the weight of the top wall is reduced while the rigidity of the restraint band and the top wall is ensured.

### Aspect 4

The battery pack according to any one of Aspects 1 to 3, wherein the second fastening member is provided in a plane that is orthogonal to both the one direction and an upward/downward direction and that includes the first fastening member.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A battery pack comprising:
a battery stack including a plurality of power storage cells arranged side by side in one direction;
a lower case that houses the battery stack;
an upper cover that covers the battery stack;
a restraint band that restrains the upper cover;
a first fastening member that fastens the upper cover to the lower case; and
a second fastening member that fastens the restraint band to the upper cover, wherein
the upper cover has a top wall provided above the battery stack,
the top wall includes a base for fastening the second fastening member,
the restraint band has a top plate portion provided above the top wall,
the top plate portion has a bead extending in the one direction,
the bead has a covering portion that covers the base, and
the second fastening member fastens the covering portion to the base.

2. The battery pack according to claim 1, wherein
the top wall has
a thin portion,
a thick portion having a thickness larger than a thickness of the thin portion, and
the base is formed at the thick portion.

3. The battery pack according to claim 2, wherein
the base has a pair of base portions provided at positions separated from each other in the one direction, and
the thin portion is formed between the pair of base portions.

4. The battery pack according to claim 1, wherein the second fastening member is provided in a plane that is orthogonal to both the one direction and an upward/downward direction and that includes the first fastening member.
